(19) United States
(12) Patent Application Publication
(10) Pub. No.: US 2025/0200559 A1
(43) Pub. Date: Jun. 19, 2025

(54) BLOCKCHAIN ENABLED ELECTRONIC AGREEMENTS

(71) Applicant: Coinbase, Inc., Oakland, CA (US)

(72) Inventors: Fu Yuen Lai, London (GB); Qi Wu, Orchard (SG); David Neil Roth, San Francisco, CA (US); Youfan Lin, Foster City, CA (US)

(21) Appl. No.: 18/542,374

(22) Filed: Dec. 15, 2023

(51) Int. Cl. G06Q 20/36

(52) U.S. Cl. CPC G06Q 20/3678

(57) ABSTRACT

Methods, systems, and devices for data management are described. An agreement service of a custodial token platform may receive, via a client application on a user device, an agreement document and respective indications of one or more blockchain addresses that are to sign the agreement document. The agreement service may broadcast first messages that are configured to generate an agreement attestation record via a blockchain network, where the agreement attestation record includes an indication of the agreement document. The agreement service may broadcast, after receiving an indication that at least one of the one or more blockchain addresses have generated a signature associated with the agreement attestation record, second messages that are configured to generate a respective signature attestation record for the at least one blockchain address via the blockchain network, where the respective signature attestation record includes a reference to the agreement attestation record.

### FIELD OF TECHNOLOGY

The present disclosure relates generally to data management, including techniques for blockchain enabled electronic agreements.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIGS. 1 and 2 shows examples of computing environments that support blockchain enabled electronic agreements in accordance with aspects of the present disclosure.

FIGS. 3 through 5 show examples of process flows that support blockchain enabled electronic agreements in accordance with aspects of the present disclosure.

FIG. 6 shows a block diagram of an apparatus that supports blockchain enabled electronic agreements in accordance with aspects of the present disclosure.

FIG. 7 shows a block diagram of a client application that supports blockchain enabled electronic agreements in accordance with aspects of the present disclosure.

FIG. 8 shows a diagram of a system including a device that supports blockchain enabled electronic agreements in accordance with aspects of the present disclosure.

FIGS. 9 and 10 show flowcharts illustrating methods that support blockchain enabled electronic agreements in accordance with aspects of the present disclosure.

### DETAILED DESCRIPTION

Agreements may be managed electronically via a centralized service provider. For example, centralized service providers may manage a lifecycle of an electronic agreement, including collecting electronic signatures. In some cases, the centralized service provider may satisfy regulatory requirements associated with electronic signatures and be designated as such. For example, the centralized service provider may be designated as a qualified trust service provider (QTSP) able to provide qualified trust services (QTS) under a regulatory body (e.g., the European Union (EU)). However, centralized service providers may be associated with high costs compared to non-electronic agreements. Further, electronic agreements may not be easily (e.g., automatically) stored in a way that users may access the agreements at a later date or if the user loses a link to the agreement. As such, decentralized electronic agreements may be associated with benefits over electronic agreements supported by centralized service providers.

As described herein, an agreement service may manage the lifecycle of an electronic agreement. For example, the agreement service may facilitate creation of electronic agreements and electronic signatures via on-chain attestations (e.g., on a decentralized blockchain ledger). A user may create or upload an agreement via the agreement service and denote signors via blockchain addresses (e.g., via decentralized identities) and/or configure smart contracts to be invoked after the signatures are complete. The agreement service may notify the signors of the agreement via a messaging service (e.g., Web3 enabled messaging, extensible message transport protocol (XMTP)). Signors may sign the agreement via the blockchain addresses (e.g., generate cryptographic signatures), and, after each of the denoted signors have generated signatures, the agreement service may generate a respective attestation record on-chain. In other words, the agreement service may generate an attestation record on-chain for each signature. A hash of the agreement may be stored as part of the agreement attestation on-chain while an agreement document may be stored via a distributed data store and/or locally by the signors. Additionally, or alternatively, the agreement may be stored by the agreement service. A third party may verify the agreement by comparing a hash of the document produced from the agreement document stored in the distributed data store against the hash of the agreement stored on-chain. In other words, the decentralized electronic agreement may provide information on-chain as verifiable proof of the agreement without revealing any information about the agreement or the signors themselves.

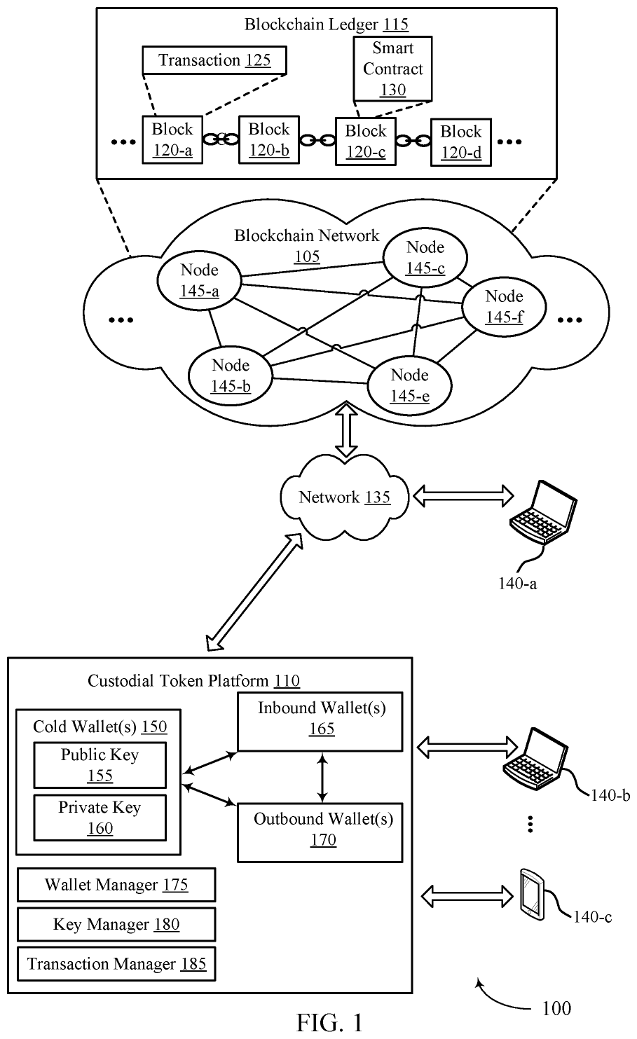

FIG. 1 illustrates an example of a computing environment 100 that supports blockchain enabled electronic agreements in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

The computing devices 140 may leverage an attestation service to create and sign electronic agreements. For example, the attestation service may be one of multiple services accessible via a client application associated with the custodial token platform 110 or the blockchain network 105. A user may create or upload an agreement via the attestation service and designate one or more signors. The attestation service may generate an attestation record for the agreement, notify the signors of the agreement via a messaging service (e.g., a messaging service of the client application, or another application) and broadcast one or more messages to generate an attestation record for the signatures of the agreement. That is, the attestation service may generate multiple attestations corresponding to the agreement itself and the signatures. For example, an agreement attestation record may be generated for the agreement itself, and signature attestation records may be generated for the signors. The signature attestation records may reference the agreement attestation record. In some examples, an initiator of the agreement may broadcast the one or more messages. For example, the agreement attestation service may notify the initiator that the attestation record is generated, and the initiator may broadcast the one or more messages to store the attestation record on-chain.

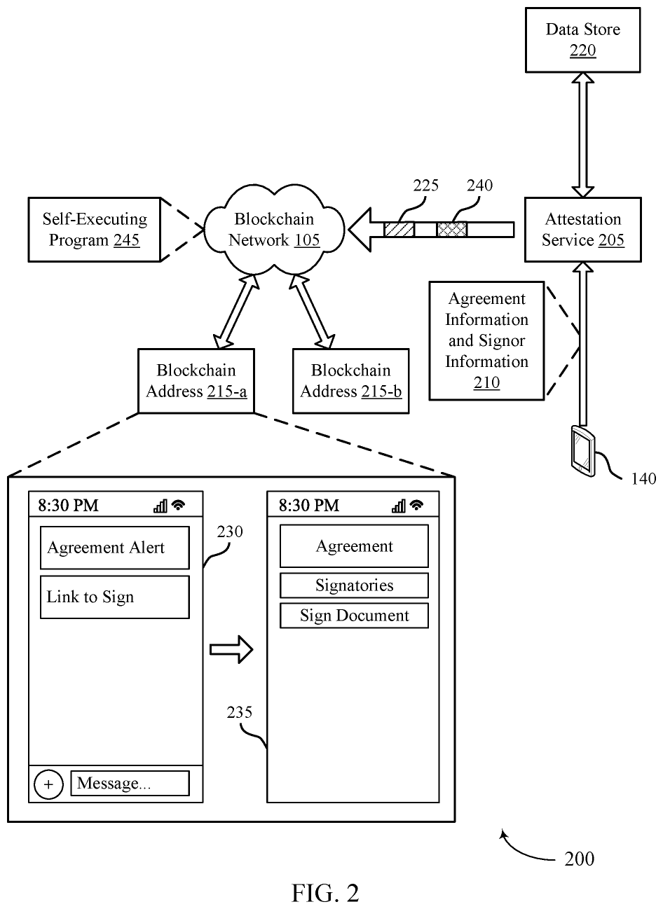

FIG. 2 shows an example of a computing environment 200 that supports blockchain enabled electronic agreements in accordance with aspects of the present disclosure. The computing environment 200 may include a blockchain network 105 and a computing device 140 which may be examples of corresponding devices as described with reference to FIG. 1. The computing environment 200 may also include an attestation service 205, which may be a service of a client application or accessible via a client application (e.g., a browser) on a computing device 140 as described with reference to FIG. 1. The attestation service 205 may be supported by a custodial token platform 110 of FIG. 1 or may be a service that is separate from the custodial token platform 110. In some examples, the attestation service 205 is an example of DApp that is supported by or is configured to access one or more smart contracts to support the techniques described herein.

The computing device 140 may create and/or sign agreements via the attestation service 205. For example, the computing device 140 may input agreement information and signor information 210 to the attestation service. The agreement information and signor information 210 may include one or more blockchain addresses, such as a blockchain address 215-a and a blockchain address 215-b. For example, the one or more blockchain addresses may represent signors for the agreement. The signors may be denoted, via the agreement information and signor information 210, as optional or required. That is, the agreement may only be considered complete after the required signors have signed the agreement, and the agreement may not require the optional signors to sign the agreement for it to be considered complete. In some examples, one of the blockchain addresses provided for the agreement information and signor information 210 may be a blockchain address associated with a user of the computing device 140, or, in some other examples, the one or more blockchain addresses may be unassociated with the user of the computing device 140.

The agreement information and signor information 210 may include information related to the agreement, such as an expiration of the agreement (e.g., an expiration date, a duration of time after signing is complete that the agreement is effective, etc.), whether the agreement is revokable, a set of terms or conditions under which the agreement is revokable (if applicable), a duration of time that signatures may be generated for the agreement, or one or more hooks (e.g., to be applied after signing, after revocation, after completion of signing, etc.). Additionally, the agreement information may include a copy of the agreement itself, and the agreement may be in the form of various document formats (e.g., .PDF, .doc. txt).

The attestation service 205 may store the agreement information and signor information 210 in a data store 220. For example, the attestation service 205 may upload an agreement document including the information related to the agreement and the signors. In some examples, the attestation service 205 may store metadata associated with the agreement. The data store 220 may be an off-chain data store. That is, the attestation service 205 may refrain from broadcasting unencrypted information associated with the agreement document on-chain (e.g., refrain from broadcasting personally identifiable information (PII) of the signors on-chain). One or more aspects of the agreement information may additionally or alternatively be stored in a decentralized data store, such as interplanetary file system (IPFS). For example, a hash of the agreement may be stored in the decentralized data store.

The attestation service 205 may broadcast first messages 225 configured to generate an agreement attestation on-chain. In some examples, the attestation service 205 may leverage a third-party attestation service to broadcast the first messages 225, or, the attestation service 205 may broadcast the first messages 225. In the case of leveraging the third-party attestation service, the attestation service 205 may transmit one or more application programming interface (API) requests to the third-party attestation service 205 and the API requests may include the agreement information. Additionally, or alternatively, the attestation service 205 may broadcast one or more blockchain messages that are configured to call a smart contract managed by the third-party attestation services. In the case of the attestation service 205 itself generating the attestations, the attestation service 205 may generate and broadcast one or more blockchain messages that are configured to generate the attestations. In any case, the attestation service 205 may create the agreement attestation on-chain based on the agreement information and signor information 210. The agreement attestation may be an instance of an attestation schema. For example, the attestation service 205 may call a schema (e.g., as stored at a smart contract on the blockchain ledger), where the call includes the agreement information and signor information 210 which fills fields of the schema. This process may result in the agreement attestation on-chain that is issued based on the agreement schema, resulting in the instance of the attestation schema. As described herein, the schema may include fields for various information, and the resulting agreement attestation may result in such information being stored on-chain. Example information that is stored on-chain may include the attestation or agreement expiration or duration, hook invocation information, hash of the agreement (e.g., hash of the file, hash of the raw text, etc.), metadata uniform resource identifier (URI), and signors (e.g., required, optional, or both). Storing such information on-chain may provide guarantees around the data availability, among other benefits.

In some examples, the attestation service 205 may broadcast the first messages 225 to generate the agreement attestation based on an initiator of the agreement, such as a user of the computing device 140, having one or more characteristics. For example, the attestation service 205 may broadcast the first messages 225 to generate the agreement attestation based on the initiator having the one or more characteristics required for the agreement. For example, the one or more characteristics may include a know-your-customer (KYC) check, a license, or the like. As an example, if the agreement attestation is related to a real estate sale, the initiator may be required to be licensed as a real estate agent in order for the attestation service 205 to broadcast the first messages 225. Thus, the attestation service 205 or another service may check these characteristics before issuing or verifying an attestation. For example, the attestation service 205 may create a set of smart contracts (e.g., via the self-executing program 245), which may be gated by an initiator address having an on-chain attestation (e.g., a trusted real estate license attestation in the case of real estate agreements).

After generating the agreement attestation, the attestation service 205 may notify the signors. For example, the signors may receive, according to the one or more blockchain addresses provided in the agreement and signor information 210, an agreement alert and a link to sign on a user interface including first content items 230. In other words, the signors may receive, at respective blockchain addresses, notifications for the agreement. In some cases, the attestation service 205 may implement or access a block processor that monitors for attestation records. For example, the block processor may monitor for attestation records according to an identifier or type of the attestation schema. In some examples, the block processor may monitor for attestation records generated by the attestation service 205. Thus, the block processor may monitor based on attestation schema ID, the attestation service, or the like, which may allow the block processor to detect agreement attestations by third party attestation services. When an agreement attestation is generated, the block processor may detect the agreement attestation on-chain, identify the signors via the attestation record, and leverage a messaging protocol (e.g., a decentralized messaging protocol, XMTP, etc.) to notify the signors of the agreement attestation and to prompt for signatures as described herein.

The signor may select the link to sign the agreement, based on which the user interface may display second content items 235 including the agreement, signatories, and an option to sign the document. The user interface may be a user interface that is displayed by a client application, blockchain wallet application, or the like. In some examples, a computing device including the user interface may access the data store 220 via the attestation service 205 (and/or the decentralized data store) to retrieve the agreement information to be displayed at the user interface. The user interface may display the signatories as blockchain addresses. If the signor opts to sign the document, the attestation service 205 may generate an agreement signature attestation. In some examples, the signor may complete one or more requirements prior to signing the document. For example, the document may be configured to require a KYC check for the signatories.

After receiving the signatures from one or more signors, the attestation service 205 may generate the agreement signature attestation by broadcasting second messages 240 configured to generate the agreement signature attestation. In some examples, the attestation service 205 may leverage a third-party attestation service to broadcast the second messages 240, or, the attestation service 205 may broadcast the second messages 240. The attestation service 205 may create the agreement signature attestation on-chain by broadcasting the messages, requesting the attention from the third-party attestation service, or the like. In some examples, the agreement signature attestation may be an instance of an attestation signature schema. For example, the attestation service 205 may create the attestation according to a data format defined by the attestation signature schema. That is, the second messages 240 may include the signor information which fills fields of the attestation signature schema resulting in an instance of an attestation schema on-chain. At least one of the fields of the schema may include a reference to the agreement attestation, such as an agreement attestation identifier. In some examples, a schema is a record in on-chain attestation service smart contract (e.g., Ethereum Attestation Service (EAS)). The schema may specify what type of information may be attested to and how the information should be presented. Accordingly, the schema is used to create attestations on-chain.

After the attestation service 205 generates respective agreement signature attestations for at least the required signors, the agreement may be considered complete. In some examples, completion of the agreement may trigger actions by a self-executing program 245 of the blockchain network 105. Additionally, or alternatively, completion of individual signatures, expiration, or revocation of the agreement may trigger actions by the self-executing program 245. For example, signing, completion of signing, expiration, or revocation may invoke a hook function referencing the self-executing program 245. In other words, the signing, completion of signing, expiration, or revocation may automatically trigger actions executed via the self-executing program 245. The post-signing or post-completion hooks may be based on inputs by the user of the user device 140 at the attestation service 205. For example, the user may input a smart contract address, an address associated with a smart contract call or function, or the like, into one or more fields corresponding to the post-signing or post-completion hooks.

The actions executed via the self-executing program 245 may include a value transfer (e.g., a transfer of crypto tokens, a non-fungible token, etc.), a deposit return process, release of payments, activation of contracts, verifying a KYC attestation, verifying that a signor has an NFT or other token, or automated access management. In some examples, signing or revocation by different signors may trigger different hook functions.

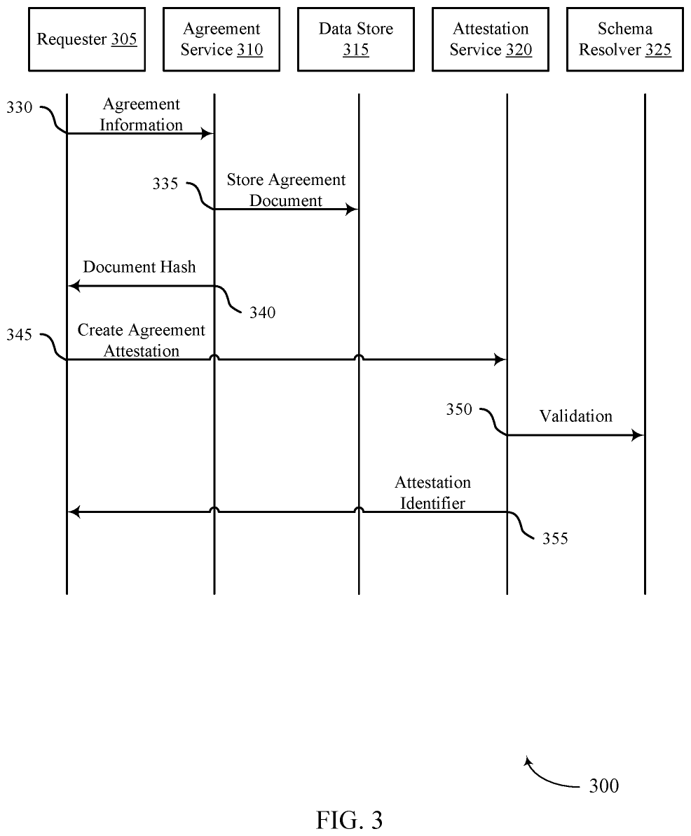

FIG. 3 shows an example of a process flow 300 that supports blockchain enabled electronic agreements in accordance with aspects of the present disclosure. In some examples, the process flow 300 may implement or be implemented by aspects of the computing environment 100 or the computing environment 200 as described with reference to FIGS. 1 and 2. For example, the process flow 300 may include a requestor 305, which may be an example of a user of the computing device 140 as described with reference to FIG. 2. Additionally, the process flow 300 may include a data store 315, which may be an example of the data store 220 in FIG. 2 (or a distributed or decentralized data store) and an agreement service 310, an attestation service 320, and a schema resolver 325 which may be examples of components of the attestation service 205 or otherwise in communication with the attestation service 205 as described with reference to FIG. 2.

Alternative examples of the following may be implemented, where some steps are performed in a different order than described or are not performed at all. In some cases, steps may include additional features not mentioned below, or further steps may be added. Although the requestor 305, the agreement service 310, the data store 315, the attestation service 320, and the schema resolver 325 are shown performing the operations of the process flow 300, some aspects of some operations may also be performed by one or more other components.

The process flow 300 may support generation of an agreement attestation. For example, the requestor 305 may initiate creation of the agreement attestation via an application including or associated with one or more of the agreement service 310, the data store 315, the attestation service 320, or the schema resolver 325. The application may be an example of a decentralized application or a “Dapp.” The requestor 305 may login or begin a session on the application via a blockchain wallet or blockchain wallet application (e.g., a browser based wallet plugin, a standalone wallet application) requestor

At 330, the requestor 305 may input agreement information to the agreement service 310. For example, the agreement information may be an example of the agreement information and signor information 210 as described with reference to FIG. 2. The agreement information may include a title, description, signatories, and an agreement document. In other words, the requestor 305 may upload information about the agreement and the agreement document to the agreement service 310. The requestor 305 may also input indications of the signors (e.g., blockchain addresses, domain names associated with blockchain addresses), post-signing hook information, post-completion hook information, or the like. The post-signing hook information and/or the post-completion hook information may include blockchain address information associated with smart contract functions.

At 335, the agreement service 310 may store the agreement document at the data store 315. For example, the agreement service 310 may upload a file containing the agreement information or the agreement document and store data related to the agreement in the data store 315. The data related to the agreement may be referred to as or an example of metadata. For example, the agreement service may be referred to as an agreement metadata service. The metadata may include an identifier, the title, the description, and/or a hash of the agreement. The data store 315 may be an off-chain storage location. That is, the agreement service 310 may store the agreement document off-chain such that information about the agreement is not publicly available on-chain. In some cases, one or more aspects of the agreement information may be stored in a decentralized data store.

In some examples, the agreement service 310 may transmit multiple, separate requests to the data store 315. For example, the agreement service 310 may transmit a first request to generate a pre-signed upload uniform resource locator (URL), a second request to upload the agreement document, and a third request to store the metadata.

After uploading the agreement document to the data store 315 at 335, the agreement service 310 may generate a hash (e.g., a cryptographic hash) and a URI. For example, the agreement service 310 may generate the hash and URI such that the document or document metadata is able to be retrieved or reproduced by a user having permissions associated with the agreement document.

At 340, the agreement service 310 may provide the document hash to the requestor 305. In some examples, the agreement service 310 may also provide the metadata URI. A signor or the requestor 305 may have the permissions associated with the agreement document and may retrieve or reproduce the document from the hash or the URI.

At 345, the requestor 305 may create an agreement attestation via the attestation service 320. For example, the requestor 305 may use the hash and metadata URI (e.g., generated by the agreement service 310 and received by the requestor 305 at 340) to create the agreement attestation with the attestation service 320. In some examples, the requestor 305 may access the attestation service via an application (e.g., a Dapp frontend), via smart contract calls, and/or via API calls. The requestor 305 may create the agreement attestation by calling an agreement schema, where the call includes information to fill the fields of the schema. For example, the schema may include fields for the hash and the metadata URI. In other words, the schema may include a field for an off-chain URI for additional information associated with the agreement, a hash of the agreement allowing for off-chain verification, or both.

The agreement schema may also include fields for an expiration of the agreement (e.g., starting from the date of completion), revocation of the agreement, signors (e.g., optional signors, required signors, or both), a signing expiration (e.g., after which additional signature attestations are not permitted), a post-signing hook function, a post-revocation hook function, and a post-completion hook function. After generation of the agreement attestation using the schema, these details may be stored on-chain.

For example, the hook functions may provide a mechanism for agreement initiators, such as the requestor 305, to run or trigger custom logic based on actions associated with the agreement. As an example, when an agreement signature attestation is generated, a post-signing hook function may be invoked based on a post-signing hook field and an address (e.g., associated with a smart contract function). Similarly, when an agreement signature attestation is revoked, for a post-revocation hook function may be invoked based on the post-revocation hook field and the address if specified. Further, when a last required agreement signature attestation is generated, for a post-completion hook function may be invoked based on the post-completion hook field and the address if specified. In some examples, an agreement signature attestation being generated may trigger both a post-signature hook and a post-completion hook (e.g., if the agreement signature attestation is a last required signature for the agreement). That is, generally, the attestation service 320 may invoke hook functions after receiving requests to generate attestations.

At 350, after receiving the request to create the attestation at 345, the attestation service 320 may validate the request via the schema resolver 325. Validating the request may involve checking to see if validation logic will be invoked based on the attestation being generated. For example, the schema resolver 325 may check a referenced attestation (e.g., the agreement attestation) for a post-signing hook field. In other words, the schema resolver 325 may check that a hook contract address is valid and that the referenced hook contract implements the hook functions. Additionally, or alternatively, the schema resolver 325 may check whether the requestor 305 may create the agreement. For example, the schema resolver 325 may check whether the requestor 305 meets a KYC requirement and/or is licensed to create the agreement. In some examples, the schema resolver 325 may also validate that the agreement includes signatories, that an expiration date occurs after a current date, or the like.

At 355, the attestation service 320 may provide an attestation identifier to the requestor 305. For example, the attestation service 320 may provide the attestation identifier as confirmation that the agreement attestation has been created. That is, the attestation service 320 may indicate the attestation identifier to the requestor 305 after broadcasting one or more messages configured to generate the agreement attestation on-chain. For example, the attestation service 320 may store at least the document hash and/or a URI on-chain (or in a distributed data store), allowing the agreement document to be retrieved and verified by users having permissions (e.g., keys) associated with the agreement document.

In some examples, after generating the agreement attestation, the agreement service 310 may notify involved signatories for the agreement via a decentralized messaging service (e.g., XMTP) according to, for example, blockchain addresses of the signatories. As described herein, the agreement service 310, or a third party service, may implement a block processor that monitors for agreement attestations and notifies signors of the agreement attestation after detection of an attestation. More particularly, the block processor may detect the agreement attestation, retrieve signor addresses, and notify the signor addresses of the agreement attestation (for signature generation) via the decentralized messaging service.

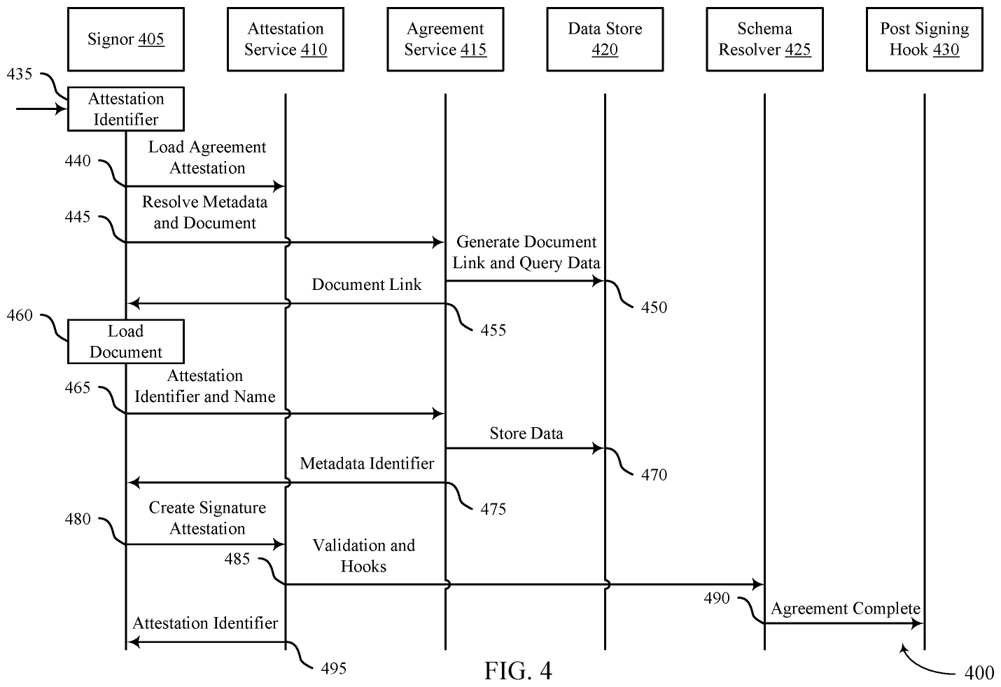

FIG. 4 shows an example of a process flow 400 that supports blockchain enabled electronic agreements in accordance with aspects of the present disclosure. In some examples, the process flow 400 may implement or be implemented by aspects of the computing environment 100 or the computing environment 200 as described with reference to FIGS. 1 and 2. For example, the process flow 400 may include a signor 405, which may be an example of a user associated with one of the blockchain addresses, such as the blockchain address 215-a as described with reference to FIG. 2. Additionally, the process flow 400 may include a data store 420, which may be an example of the data store 220 in FIG. 2 and an attestation service 410, an agreement service 415, a schema resolver 425, and a post signing hook 430 which may be examples of components of the attestation service 205 or otherwise in communication with the attestation service 205 as described with reference to FIG. 2.

Alternative examples of the following may be implemented, where some steps are performed in a different order than described or are not performed at all. In some cases, steps may include additional features not mentioned below, or further steps may be added. Although the signor 405, the attestation service 410, the agreement service 415, the data store 420, the schema resolver 425, and the post signing hook 430 are shown performing the operations of the process flow 400, some aspects of some operations may also be performed by one or more other components.

The process flow 400 may support generation of an agreement signature attestation. For example, the signor 405 may receive a notification of an agreement, such as the agreement generated as described with reference to FIG. 3, and generate an agreement signature attestation. The signor 405 may create the agreement signature attestation via an application including one or more of the attestation service 410, the agreement service 415, the data store 420, the schema resolver 425, or the post signing hook 430. The application may be an example of a decentralized application or a “Dapp” and/or a wallet application. The signor 405 may login or begin a session on the application via a blockchain wallet.

At 435, the signor 405 may receive an indication of an attestation identifier. For example, the signor 405 may receive the indication of the attestation identifier associated with an agreement attestation. The signor 405 may receive the indication based on being designated as a signor (e.g., a required or optional signor) for the agreement. The indication may be received via a decentralized messaging protocol, as described herein. Additionally, or alternatively, the indication may be provided directly or manually via a centralized messaging protocol.

The signor 405 may retrieve the document after receiving the attestation identifier. For example, the signor 405 (or the application associated with the signor) may transmit a request to the attestation service 410 at 440 to load the agreement attestation. The signor 405 may unpack a metadata URI, a document URI, or both from the agreement attestation. The signor 405 may use the revealed metadata URI or the document URI to retrieve the document from the agreement service 415. For example, at 445, the signor 405 may resolve the metadata URI and document URI with the agreement service 415. The agreement service 415 may generate a document link and query data at 420 from the data store 420 based on receiving an indication of the metadata URI or the document URI from the signor 405. Finally, the agreement service 415 may provide a document link to the signor 405 at 455, and the signor 405 may load the document at 460. For example, the agreement service 415 may provide the document link, metadata, or both to the signor 405 based on which the signor 405 may load the document. In some examples, a frontend of the application (e.g., a Dapp frontend) may load the agreement attestation data from the attestation service 410, load the document on a user interface of a computing device of the signor 405, or both.

If the signor 405 opts to sign the agreement, the signor may initiate (e.g., via the blockchain wallet application) creation of a signature attestation. In some cases, based on receiving the agreement information, the wallet application may prompt for the signature. For example, at 465, the signor 405 may provide the agreement attestation identifier and a signor name to the agreement service 415. Based on receiving the attestation identifier and signor name, at 470, the agreement service 415 may store the data associating the agreement attestation identifier with the signor name at the data store 420. After storing the data at the data store 420, the agreement service 415 may return a metadata identifier, such as a metadata URI, to the signor 405 at 475. In other words, if the signor 405 opts to sign the agreement, they may create metadata related to the agreement attestation identifier.

At 480, the signor 405 may create a signature attestation via the attestation service 410. For example, the signor 405 may use the metadata URI (e.g., generated by the agreement service 415 and received by the signor 405 at 475) to create the signature attestation with the attestation service 410. In some examples, the signor 405 may access the attestation service 410 via an application (e.g., a Dapp frontend and/or wallet application). The signor 405 may create the signature attestation by activating a UI on the application, which may result in the attestation service 410 calling a schema, where the call includes information to fill the fields of the schema. For example, the schema may include fields for a reference to an agreement attestation (e.g., the attestation identifier) and the metadata URI and/or a hash of the metadata. In other words, the schema may include a field for an off-chain URI for additional information associated with the signor 405 and the agreement. The schema may also include fields for an expiration of the signature (e.g., starting from the date of completion or the date of signing), revocation of the signature, an indication that the signor agrees to the terms of the referenced agreement, or a cryptographic hash. For example, the cryptographic hash may be a version of a hash associated with the agreement attestation which is modified according to the signature. The cryptographic hash may enable off-chain verification of the electronic agreement. In some examples, the verification may serve as proof of the electronic agreement.

At 485, after receiving the request to create the signature attestation at 480, the attestation service 410 may validate the request with the schema resolver 425. Validating the request may involve checking to see if validation logic will be invoked based on the attestation being generated. For example, the schema resolver 425 may invoke the post signing hook 430 at 490 after generating the signature attestation. In some examples, the schema resolver 425 may also invoke a post completion hook if, for example, the signature attestation is generated for a last signatory of an agreement document. Additionally, or alternatively, validating the request may involve checking to see if the signor 405 meets one or more requirements (e.g., a KYC requirement) associated with the agreement document. For example, the attestation service 410 may retrieve applicable requirements for the agreement document from the schema resolver 425 and refrain from generating the signature attestation based on the signor 405 failing to meet the applicable requirements, or, in other examples, proceed with generating the signature attestation based on the signor 405 meeting the applicable requirements.

At 495, the attestation service 410 may provide an attestation identifier to the signor 405. For example, the attestation service 410 may provide the attestation identifier as confirmation that the signature attestation has been created. That is, the attestation service 410 may indicate the attestation identifier to the signor 405 after broadcasting one or more messages configured to generate the signature attestation on-chain. For example, the attestation service 410 may store at least the signature hash on-chain, allowing the signature for the referenced agreement document to be retrieved and verified by users having certain permissions (e.g., keys) associated with the agreement document.

In some examples, after generating the signature attestation, the agreement service 415 or a third party service may notify involved signatories, the requestor, or both via a messaging service (e.g., a decentralized messaging service, XMTP, etc.) that a signature has been completed for the agreement according to, for example, blockchain addresses of the signatories or requestor.

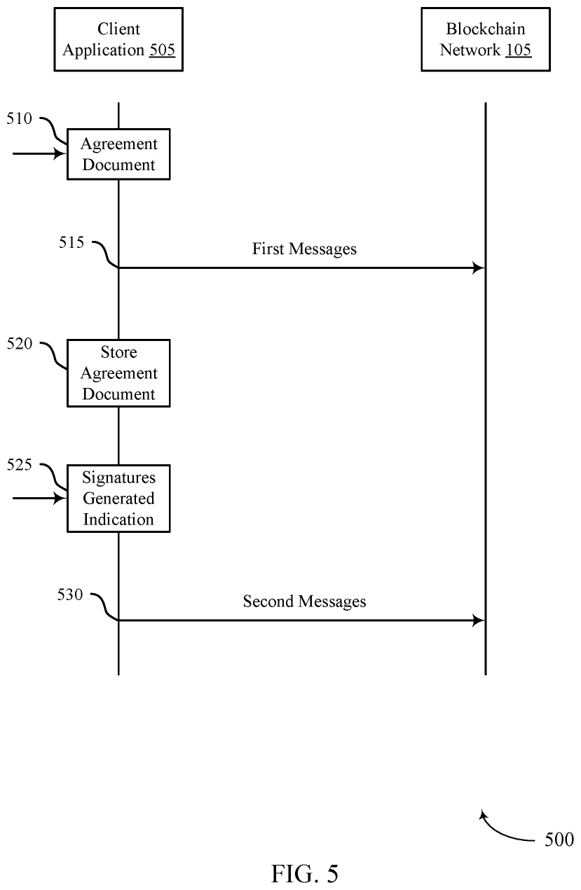

FIG. 5 shows an example of a process flow 500 that supports blockchain enabled electronic agreements in accordance with aspects of the present disclosure. In some examples, the process flow 500 may implement or be implemented by aspects of the computing environment 100 or the computing environment 200 as described with reference to FIGS. 1 and 2. For example, the process flow 500 may include a client application 505, which may be an example of the applications supporting generation of agreement attestations and signature attestations as described with reference to FIGS. 3 and 4. Additionally, the process flow 500 may include a blockchain network 105, which may be an example of the blockchain network 105 as described with reference to FIGS. 1 and 2.

Alternative examples of the following may be implemented, where some steps are performed in a different order than described or are not performed at all. In some cases, steps may include additional features not mentioned below, or further steps may be added. Although the client application 505 and the blockchain network 105 are shown performing the operations of the process flow 500, some aspects of some operations may also be performed by one or more other components.

The process flow 500 may support generation of an agreement attestation and agreement signature attestations. The client application 505 may be an example of a decentralized application or a “Dapp,” The client application 505 may generate the attestations via the blockchain network 105 or may leverage an external or third party service to generate the attestations.

At 505, the client application 505 may receive an agreement document. For example, the client application 505 may include or may be configured to access an agreement service. The agreement service may receive the agreement document via the client application 505 on a user device. Additionally, or alternatively, the agreement service may receive one or more blockchain addresses that are to sign the agreement document.

At 515, the client application 505 may broadcast one or more first messages to the blockchain network 105. For example, the agreement service of the client application 505 may broadcast the one or more first messages that are configured to generate an agreement attestation record via the blockchain network 105, where the agreement attestation record includes an indication of the agreement document. The indication of the agreement document may be a hash value of the agreement document. In some examples, the agreement service may leverage an attestation service (e.g., a third party or external service) to generate the agreement attestation record. For example, the agreement service may transmit the indication of the agreement document to the attestation service, and the attestation service may generate the attestation based on the indication. In some other examples, the agreement service may generate the agreement attestation via the blockchain network 105 directly (e.g., as a first party service). In such examples, the agreement service may broadcast the one or more first messages to generate the attestation. Additionally, or alternatively, the client application 505 may broadcast the one or more first messages directly to the blockchain network 105 (e.g., without the agreement service). In such cases, the agreement service may generate the attestation for signing by the client application 505, and the client application 505 may broadcast the one or more first messages to generate the agreement attestation on-chain. In the case of using the third-party service, the one or more first messages may be blockchain messages that are configured to call a smart contract associated with the agreement attestation service. Additionally, or alternatively, the one or more first messages may be API request messages that cause the third-party attestation service to generate the attestations on-chain.

Additionally, or alternatively, the one or more first messages may be configured to cause transmission of a notification message to the one or more blockchain addresses. For example, generation of the agreement attestation may cause transmission (e.g., via the decentralized messaging service) of the notification messages to the blockchain addresses. The notification message may indicate the agreement attestation record. For example, the notification message may include an identifier of the agreement attestation record. The recipients may use the identifier to retrieve and sign the agreement (e.g., or generally act on the agreement).

In some examples, the one or more first messages may be configured to call a schema for the agreement attestation record stored on a self-executing program to generate the agreement attestation record. For example, the one or more first messages may include information corresponding to each field of the schema. The self-executing program may be associated with or stored on the blockchain network 105.

At 520, the client application 505 may store the agreement document in association with the hash value of the agreement document in a data store. For example, a signor, after receiving the notification message, may retrieve the agreement document from the data store and via the client application 505 (or an agreement service of the client application) by referencing the hash value.

At 525, the client application 505 may receive an indication that the signatures are generated. For example, the client application 505 may receive an indication that at least one of the one or more blockchain addresses have generated a signature associated with the agreement attestation record. In some examples, the client application 505 may identify that at least one signature is generated via the agreement service of the client application 505, or, in some other examples, receive an indication from an external service that at least one signature is generated.

At 530, the client application 505 may broadcast one or more second messages that are configured to generate a respective signature attestation record for the at least one blockchain address via the blockchain network, where the respective signature attestation record includes a reference to the agreement attestation record. For example, the signature attestation record may include an identifier of the agreement attestation record or a modified hash value of the agreement document. As described with respect to the one or more first messages, the one or more second messages may be broadcast directly on-chain generate the attestation record, or in the case of use of a third-party attestation service, the one or more second messages may call a smart contract associated with the third-party attestation services or may be API calls to the third-party attestation service. In the case of the client application 505 broadcasting the one or more second messages, the agreement attestation service may generate the unsigned attestation for signing via the client application 505.

In some examples, the one or more second messages may be configured to invoke a hook contract that is included in the agreement attestation record, where the hook contract indicates a hook function that references a self-executing program supported by the blockchain network 105. For example, the hook function may be a post signing hook that is invoked for each generated signature, a post completion hook that is invoked after generation of all signatures, or both. In some examples, the reference to the self-executing program may be received via the client application 505 of the user device. That is, the client application 505 may provide a hook address with the document information in the one or more second messages.

Additionally, or alternatively, the one or more second messages may be configured to call a schema corresponding to the respective signature attestation record stored on the self-executing program to generate the respective signature attestation record. For example, the one or more second messages may include information corresponding to each field of the schema, such as an identifier for the agreement or of the signor.

In some examples, a schema associated with the signature attestation record may include an indication of a resolver self-executing program that validates the signature for the signature attestation record and prevents generation of signature records for unspecified blockchain addresses. In other words, the schema may validate each signature.

In some examples, a hash of the agreement attestation record, a hash of the signature attestation record, or both may be stored on-chain while a corresponding agreement document or signature document may be stored off-chain. The agreement and/or the signatures may be verified by comparing a hash of the document produced from the documents stored off-chain against the hashes stored on-chain. In other words, the decentralized electronic agreement may provide information on-chain as verifiable proof of the agreement without revealing any information about the agreement or the signors themselves.

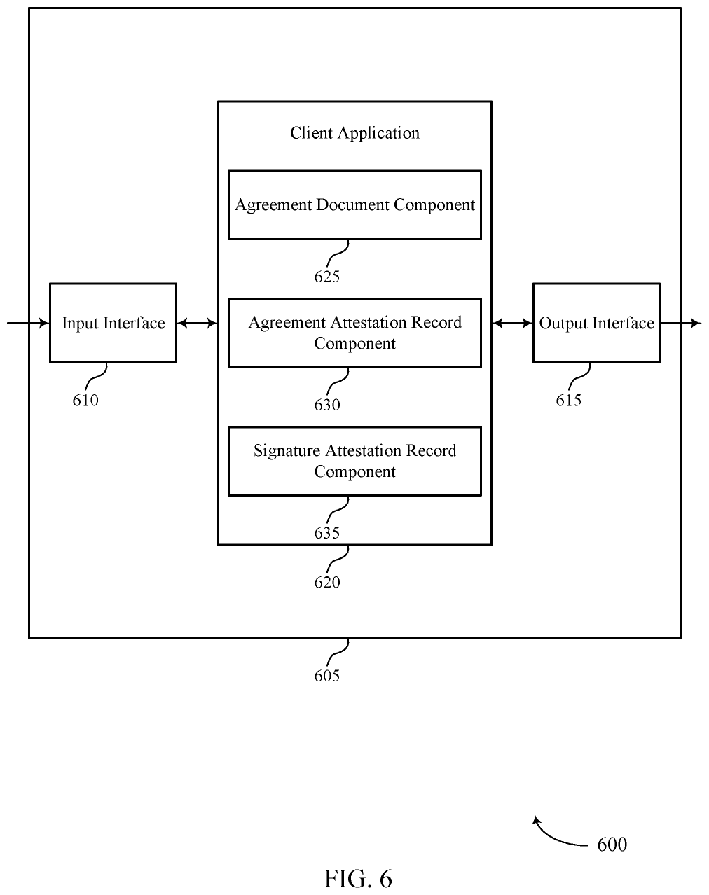

FIG. 6 shows a block diagram 600 of a device 605 that supports blockchain enabled electronic agreements in accordance with aspects of the present disclosure. The device 605 may include an input interface 610, an output interface 615, and a client application 620. The device 605, or one or more components of the device 605 (e.g., the input interface 610, the output interface 615, and the client application 620), may include at least one processor, which may be coupled with at least one memory, to support the described techniques. Each of these components may communicate, directly or indirectly, with one another (e.g., via one or more buses, communications links, communications interfaces, or any combination thereof).

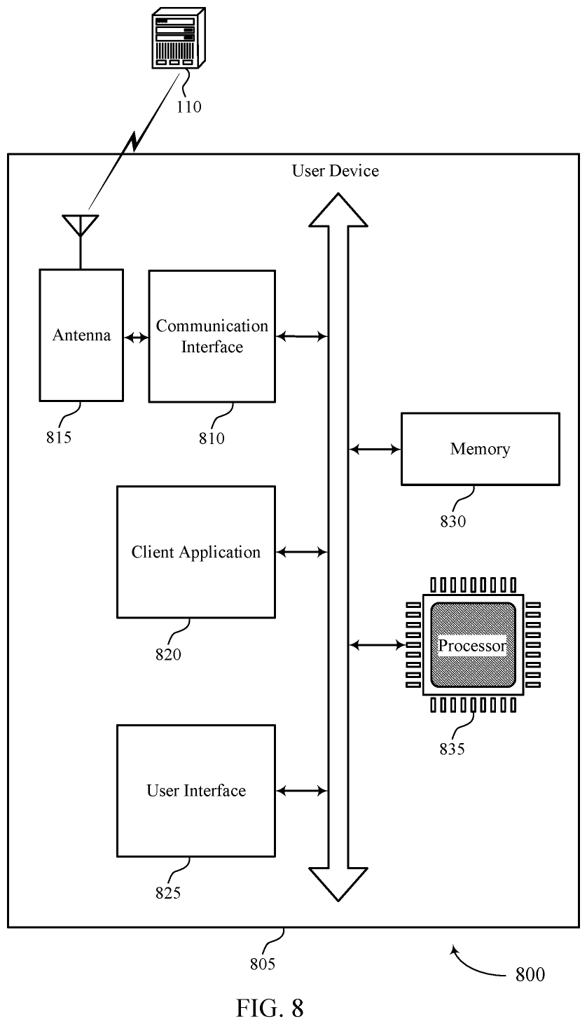

The input interface 610 may manage input signaling for the user device 605. For example, the input interface 610 may receive input signaling (e.g., messages, packets, data, instructions, commands, transactions, or any other form of encoded information) from other systems or devices. The input interface 610 may send signaling corresponding to (e.g., representative of or otherwise based on) such input signaling to other components of the user device 605 for processing. For example, the input interface 610 may transmit such corresponding signaling to the client application 620 to support blockchain enabled electronic agreements. In some cases, the input interface 610 may be a component of a 810 as described with reference to FIG. 8.

The output interface 615 may manage output signaling for the user device 605. For example, the output interface 615 may receive signaling (e.g., messages, packets, data, instructions, commands, transactions, or any other form of encoded information) from other components of the user device 605 such as the client application 620 and may transmit output signaling corresponding to (e.g., representative of or otherwise based on) such signaling to other systems or devices to support blockchain enabled electronic agreements. In some cases, the output interface 615 may be a component of a 810 as described with reference to FIG. 8.

For example, the client application 620 may include an agreement document component 625, an agreement attestation record component 630, a signature attestation record component 635, or any combination thereof. In some examples, the client application 620, or various components thereof, may be configured to perform various operations (e.g., receiving, monitoring, transmitting) using or otherwise in cooperation with the input interface 610, the output interface 615, or both. For example, the client application 620 may receive information from the input interface 610, send information to the output interface 615, or be integrated in combination with the input interface 610, the output interface 615, or both to receive information, transmit information, or perform various other operations as described herein.

The client application 620 may support data management in accordance with examples as disclosed herein. The agreement document component 625 may be configured as or otherwise support a means for receiving, via a client application on a user device, an agreement document and respective indications of one or more blockchain addresses that are to sign the agreement document. The agreement attestation record component 630 may be configured as or otherwise support a means for broadcasting one or more first messages that are configured to generate an agreement attestation record via a blockchain network, wherein the agreement attestation record includes an indication of the agreement document. The signature attestation record component 635 may be configured as or otherwise support a means for broadcasting, after receiving an indication that at least one of the one or more blockchain addresses have generated a signature associated with the agreement attestation record, one or more second messages that are configured to generate a respective signature attestation record for the at least one blockchain address via the blockchain network, wherein the respective signature attestation record includes a reference to the agreement attestation record.

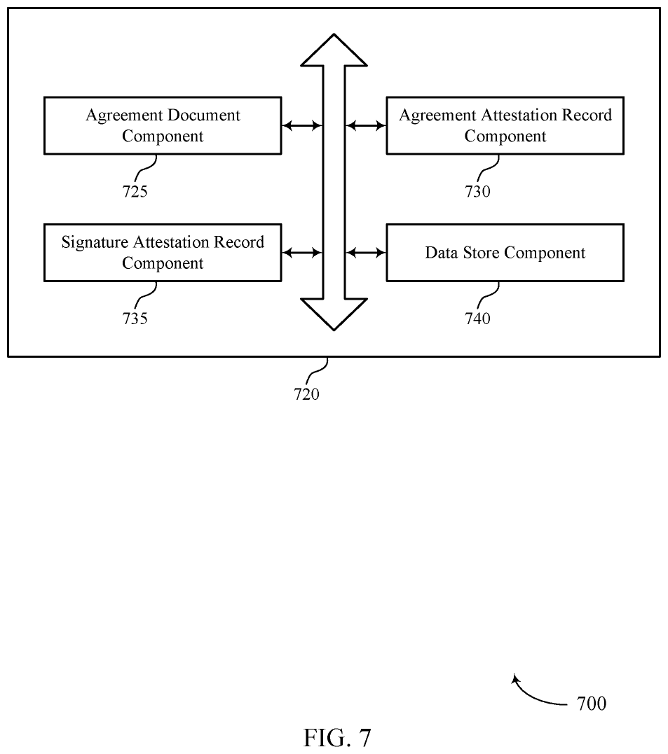

FIG. 7 shows a block diagram 700 of a client application 720 that supports blockchain enabled electronic agreements in accordance with aspects of the present disclosure. The client application 720 may be an example of aspects of a client application or a client application 620, or both, as described herein. The client application 720, or various components thereof, may be an example of means for performing various aspects of blockchain enabled electronic agreements as described herein. For example, the client application 720 may include an agreement document component 725, an agreement attestation record component 730, a signature attestation record component 735, a data store component 740, or any combination thereof. Each of these components may communicate, directly or indirectly, with one another (e.g., via one or more buses, communications links, communications interfaces, or any combination thereof).

The client application 720 may support data management in accordance with examples as disclosed herein. The agreement document component 725 may be configured as or otherwise support a means for receiving, via a client application on a user device, an agreement document and respective indications of one or more blockchain addresses that are to sign the agreement document. The agreement attestation record component 730 may be configured as or otherwise support a means for broadcasting one or more first messages that are configured to generate an agreement attestation record via a blockchain network, wherein the agreement attestation record includes an indication of the agreement document. The signature attestation record component 735 may be configured as or otherwise support a means for broadcasting, after receiving an indication that at least one of the one or more blockchain addresses have generated a signature associated with the agreement attestation record, one or more second messages that are configured to generate a respective signature attestation record for the at least one blockchain address via the blockchain network, wherein the respective signature attestation record includes a reference to the agreement attestation record.

In some examples, the one or more second messages are configured to invoke a hook contract that is included in the agreement attestation record, wherein the hook contract indicates a hook function that references a self-executing program supported by the blockchain network.

In some examples, the hook function is a post signing hook that is invoked for each generated signature by the one or more blockchain addresses.

In some examples, the hook function is a post completion hook that is invoked after generation of all signatures by the one or more blockchain addresses.

In some examples, the reference to the self-executing program is received via the client application on the user device.

In some examples, the one or more first messages are further configured to cause transmission of a notification message to the one or more blockchain addresses and wherein the notification message is indicative of the agreement attestation record.

In some examples, the one or more first messages are configured to call a schema for the agreement attestation record stored on a self-executing program to generate the agreement attestation record.

In some examples, the one or more second messages are configured to call a schema for corresponding to the respective signature attestation record stored on a self-executing program to generate the respective signature attestation record.

In some examples, the indication of the agreement document included in the agreement attestation record comprises a hash value of the agreement document.

In some examples, the data store component 740 may be configured as or otherwise support a means for storing the agreement document in association with a hash value of the agreement document in a data store.

In some examples, a schema associated with the signature attestation record includes an indication of a resolver self-executing program that validates the signature for the signature attestation record and prevents generation of signature attestation records for unspecified blockchain addresses.

FIG. 8 shows a diagram 800 including a device 805 that supports blockchain enabled electronic agreements in accordance with aspects of the present disclosure. The device 805 may be an example of or include the components of a device 605 as described herein. The device 805 may include components for blockchain enabled electronic agreements, such as a client application 820, a communication interface 810, an antenna 815, a user interface 825, at least one memory 830, and at least one processor 835. Each of these components may communicate, directly or indirectly, with one another (e.g., via one or more buses, communications links, communications interfaces, or any combination thereof).

The communication interface 810 may manage input and output signals for the device 805 via the antenna 815. For example, the communication interface 810 may enable the user device 805 to exchange information (e.g., input information, output information, or both) with other systems or devices, such as custodial token platform 110 (e.g., supported by one or more servers), via one or more wired or wireless communication links. The communication interface 810 may also utilize or interact with antenna 815 to support communication with other systems or devices. In some cases, the communication interface 810 may represent a physical connection or port to an external peripheral, such as a hardware wallet device. In some cases, the communication interface 810 may utilize an operating system such as iOS®, ANDROID®, MS-DOS®, MS-WINDOWS®, OS/2®, UNIX®, LINUX®, or another known operating system. The communication interface 810 may be implemented as part of the processor 835.

In some cases, the device 805 may include a single antenna 815. However, in some other cases, the device 805 may have more than one antenna 815, which may be capable of concurrently transmitting or receiving multiple wireless transmissions. The communication interface 810 may communicate bi-directionally, via the one or more antennas 815, wired, or wireless links as described herein. For example, the communication interface 810 may represent a wireless transceiver and may communicate bi-directionally with another wireless transceiver. The communication interface 810 may also include a modem to modulate the packets, to provide the modulated packets to one or more antennas 815 for transmission, and to demodulate packets received from the one or more antennas 815.

The user interface 825 may represent interact with a keyboard, a mouse, a touchscreen, a microphone, or a similar device or component. In some cases, a user may interact with the user interface 825. In other cases, the user interface 825 may operate automatically without user interaction. The user interface 825 may display or output information such as information received from other systems or devices or information to be transmitted to other systems or devices.

The memory 830 may include RAM and ROM. The memory 830 may store computer-readable, computer-executable software including instructions that, when executed, cause at least one processor 835 to perform various functions described herein. In some cases, the memory 830 may contain, among other things, a BIOS which may control basic hardware or software operation such as the interaction with peripheral components or devices. The memory 830 may be an example of a single memory or multiple memories. For example, the user device 805 may include one or more memories 830.

The processor 835 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 835 may be configured to operate a memory array using a memory controller. In other cases, a memory controller may be integrated into the processor 835. The processor 835 may be configured to execute computer-readable instructions stored in at least one memory 830 to perform various functions (e.g., functions or tasks supporting a method and system for blockchain enabled electronic agreements). Though a single processor 835 is depicted in the example of FIG. 8, it is to be understood that the user device 805 may include any quantity of one or more of processors 835 and that a group of processors 835 may collectively perform one or more functions ascribed herein to a processor, such as the processor 835. The processor 835 may be an example of a single processor or multiple processors. For example, the device 805 may include one or more processors 835.

The client application 820 may support data management in accordance with examples as disclosed herein. For example, the client application 820 may be configured as or otherwise support a means for receiving, via a client application on a user device, an agreement document and respective indications of one or more blockchain addresses that are to sign the agreement document. The client application 820 may be configured as or otherwise support a means for broadcasting one or more first messages that are configured to generate an agreement attestation record via a blockchain network, wherein the agreement attestation record includes an indication of the agreement document. The client application 820 may be configured as or otherwise support a means for broadcasting, after receiving an indication that at least one of the one or more blockchain addresses have generated a signature associated with the agreement attestation record, one or more second messages that are configured to generate a respective signature attestation record for the at least one blockchain address via the blockchain network, wherein the respective signature attestation record includes a reference to the agreement attestation record.

By including or configuring the client application 820 in accordance with examples as described herein, the device 805 may support techniques for improved user experience related to agreement signatures. For example, instead of relying on a centralized signature application, the techniques described herein support leveraging decentralized aspects of blockchain networks and wallet applications to support improved user experience. Additionally, as blockchain networks may be pseudo-anonymous, the agreements may be signed, and signatures may be proven, without revealing either the signors or the agreement itself, which provides improved user experience and data security.

The client application 820 may include an application (e.g., “app”), program, software, extension, Dapp, or other component which is configured to facilitate communications with a custodial token platform 110 on a server, one or more nodes of a blockchain network 105, other user devices 805, and other devices or systems. For example, the client application 820 may be an application executable on the user device 805 or accessible via an application on the user device, and the client application 820 may be configured to receive data from a custodial token platform 110, transmit data to the custodial token platform 110, process such data, and cause presentation of such data to a user via a user interface 825. The client application 820 may be an example of a wallet application, a wallet device, or both, and may be associated with a wallet address and may access or use a private key to sign messages to facilitate transfer of crypto tokens, messages, transactions, or the like via a blockchain distributed data store.

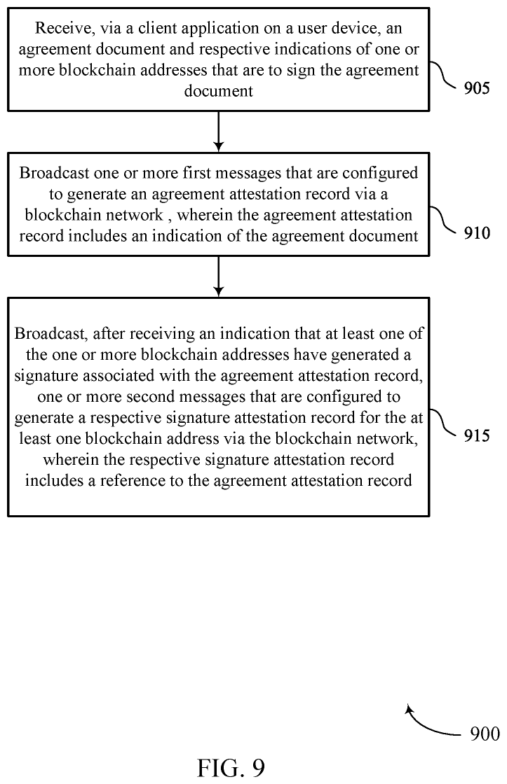

FIG. 9 shows a flowchart illustrating a method 900 that supports blockchain enabled electronic agreements in accordance with aspects of the present disclosure. The operations of the method 900 may be implemented by a user device or its components as described herein. For example, the operations of the method 900 may be performed by a user device as described with reference to FIGS. 1 through 8. In some examples, a user device may execute a set of instructions to control the functional elements of the user device to perform the described functions. Additionally, or alternatively, the user device may perform aspects of the described functions using special-purpose hardware.

At 905, the method may include receiving, via a client application on a user device, an agreement document and respective indications of one or more blockchain addresses that are to sign the agreement document. The operations of block 905 may be performed in accordance with examples as disclosed herein. In some examples, aspects of the operations of 905 may be performed by an agreement document component 725 as described with reference to FIG. 7.

At 910, the method may include broadcasting one or more first messages that are configured to generate an agreement attestation record via a blockchain network, wherein the agreement attestation record includes an indication of the agreement document. The operations of block 910 may be performed in accordance with examples as disclosed herein. In some examples, aspects of the operations of 910 may be performed by an agreement attestation record component 730 as described with reference to FIG. 7.

At 915, the method may include broadcasting, after receiving an indication that at least one of the one or more blockchain addresses have generated a signature associated with the agreement attestation record, one or more second messages that are configured to generate a respective signature attestation record for the at least one blockchain address via the blockchain network, wherein the respective signature attestation record includes a reference to the agreement attestation record. The operations of block 915 may be performed in accordance with examples as disclosed herein. In some examples, aspects of the operations of 915 may be performed by a signature attestation record component 735 as described with reference to FIG. 7.

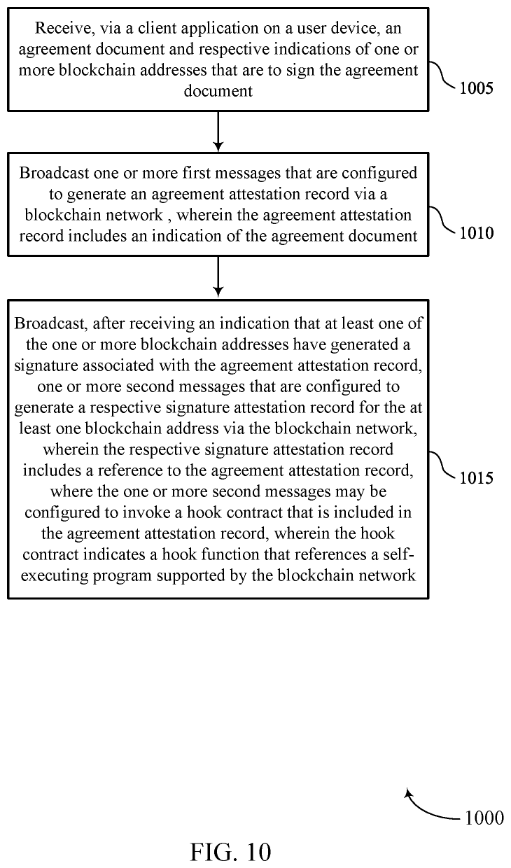

FIG. 10 shows a flowchart illustrating a method 1000 that supports blockchain enabled electronic agreements in accordance with aspects of the present disclosure. The operations of the method 1000 may be implemented by a user device or its components as described herein. For example, the operations of the method 1000 may be performed by a user device as described with reference to FIGS. 1 through 8. In some examples, a user device may execute a set of instructions to control the functional elements of the user device to perform the described functions. Additionally, or alternatively, the user device may perform aspects of the described functions using special-purpose hardware.

At 1005, the method may include receiving, via a client application on a user device, an agreement document and respective indications of one or more blockchain addresses that are to sign the agreement document. The operations of block 1005 may be performed in accordance with examples as disclosed herein. In some examples, aspects of the operations of 1005 may be performed by an agreement document component 725 as described with reference to FIG. 7.

At 1010, the method may include broadcasting one or more first messages that are configured to generate an agreement attestation record via a blockchain network, wherein the agreement attestation record includes an indication of the agreement document. The operations of block 1010 may be performed in accordance with examples as disclosed herein. In some examples, aspects of the operations of 1010 may be performed by an agreement attestation record component 730 as described with reference to FIG. 7.

At 1015, the method may include broadcasting, after receiving an indication that at least one of the one or more blockchain addresses have generated a signature associated with the agreement attestation record, one or more second messages that are configured to generate a respective signature attestation record for the at least one blockchain address via the blockchain network, wherein the respective signature attestation record includes a reference to the agreement attestation record. In some examples, the one or more second messages may be configured to invoke a hook contract that is included in the agreement attestation record, where the hook contract indicates a hook function that references a self-executing program supported by the blockchain network. The operations of block 1015 may be performed in accordance with examples as disclosed herein. In some examples, aspects of the operations of 1015 may be performed by a signature attestation record component 735 as described with reference to FIG. 7.

A method for data management by an apparatus is described. The method may include receiving, via a client application on a user device, an agreement document and respective indications of one or more blockchain addresses that are to sign the agreement document, broadcasting one or more first messages that are configured to generate an agreement attestation record via a blockchain network, wherein the agreement attestation record includes an indication of the agreement document, and broadcasting, after receiving an indication that at least one of the one or more blockchain addresses have generated a signature associated with the agreement attestation record, one or more second messages that are configured to generate a respective signature attestation record for the at least one blockchain address via the blockchain network, wherein the respective signature attestation record includes a reference to the agreement attestation record.

An apparatus for data management is described. The apparatus may include one or more memories storing processor executable code, and one or more processors coupled with the one or more memories. The one or more processors may individually or collectively operable to execute the code to cause the apparatus to receive, via a client application on a user device, an agreement document and respective indications of one or more blockchain addresses that are to sign the agreement document, broadcast one or more first messages that are configured to generate an agreement attestation record via a blockchain network, wherein the agreement attestation record includes an indication of the agreement document, and broadcast, after receiving an indication that at least one of the one or more blockchain addresses have generated a signature associated with the agreement attestation record, one or more second messages that are configured to generate a respective signature attestation record for the at least one blockchain address via the blockchain network, wherein the respective signature attestation record includes a reference to the agreement attestation record.

Another apparatus for data management is described. The apparatus may include means for receiving, via a client application on a user device, an agreement document and respective indications of one or more blockchain addresses that are to sign the agreement document, means for broadcasting one or more first messages that are configured to generate an agreement attestation record via a blockchain network, wherein the agreement attestation record includes an indication of the agreement document, and means for broadcasting, after receiving an indication that at least one of the one or more blockchain addresses have generated a signature associated with the agreement attestation record, one or more second messages that are configured to generate a respective signature attestation record for the at least one blockchain address via the blockchain network, wherein the respective signature attestation record includes a reference to the agreement attestation record.

A non-transitory computer-readable medium storing code for data management is described. The code may include instructions executable by one or more processors to receive, via a client application on a user device, an agreement document and respective indications of one or more blockchain addresses that are to sign the agreement document, broadcast one or more first messages that are configured to generate an agreement attestation record via a blockchain network, wherein the agreement attestation record includes an indication of the agreement document, and broadcast, after receiving an indication that at least one of the one or more blockchain addresses have generated a signature associated with the agreement attestation record, one or more second messages that are configured to generate a respective signature attestation record for the at least one blockchain address via the blockchain network, wherein the respective signature attestation record includes a reference to the agreement attestation record.

In some examples of the method, apparatus, and non-transitory computer-readable medium described herein, the one or more second messages may be configured to invoke a hook function that may be included in the agreement attestation record, wherein the hook function references a self-executing program supported by the blockchain network.

In some examples of the method, apparatus, and non-transitory computer-readable medium described herein, the hook function may be a post signing hook that may be invoked for each generated signature by the one or more blockchain addresses.

In some examples of the method, apparatus, and non-transitory computer-readable medium described herein, the hook function may be a post completion hook that may be invoked after generation of all signatures by the one or more blockchain addresses.

In some examples of the method, apparatus, and non-transitory computer-readable medium described herein, the reference to the self-executing program may be received via the client application on the user device.

In some examples of the method, apparatus, and non-transitory computer-readable medium described herein, the one or more first messages may be further configured to cause transmission of a notification message to the one or more blockchain addresses and wherein the notification message may be indicative of the agreement attestation record.

In some examples of the method, apparatus, and non-transitory computer-readable medium described herein, the one or more first messages may be configured to call a schema for the agreement attestation record stored on a self-executing program to generate the agreement attestation record.

In some examples of the method, apparatus, and non-transitory computer-readable medium described herein, the one or more second messages may be configured to call a schema for corresponding to the respective signature attestation record stored on a self-executing program to generate the respective signature attestation record.

In some examples of the method, apparatus, and non-transitory computer-readable medium described herein, the indication of the agreement document included in the agreement attestation record comprises a hash value of the agreement document.

Some examples of the method, apparatus, and non-transitory computer-readable medium described herein may further include operations, features, means, or instructions for storing the agreement document in association with a hash value of the agreement document in a data store.

In some examples of the method, apparatus, and non-transitory computer-readable medium described herein, a schema associated with the signature attestation record includes an indication of a resolver self-executing program that validates the signature for the signature attestation record and prevents generation of signature attestation records for unspecified blockchain addresses.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for data management, comprising:
receiving, via a client application on a user device, an agreement document and respective indications of one or more blockchain addresses that are to sign the agreement document;
broadcasting one or more first messages that are configured to generate an agreement attestation record via a blockchain network, wherein the agreement attestation record includes an indication of the agreement document; and
broadcasting, after receiving an indication that at least one of the one or more blockchain addresses have generated a signature associated with the agreement attestation record, one or more second messages that are configured to generate a respective signature attestation record for the at least one blockchain address via the blockchain network, wherein the respective signature attestation record includes a reference to the agreement attestation record.

2. The method of claim 1, wherein the one or more second messages are configured to invoke a hook contract that is included in the agreement attestation record, wherein the hook contract indicates a hook function that references a self-executing program supported by the blockchain network.

3. The method of claim 2, wherein the hook function is a post signing hook that is invoked for each generated signature by the one or more blockchain addresses.

4. The method of claim 2, wherein the hook function is a post completion hook that is invoked after generation of all signatures by the one or more blockchain addresses.

5. The method of claim 2, wherein the reference to the self-executing program is received via the client application on the user device.

6. The method of claim 1, wherein the one or more first messages are further configured to cause transmission of a notification message to the one or more blockchain addresses and wherein the notification message is indicative of the agreement attestation record.

7. The method of claim 1, wherein the one or more first messages are configured to call a schema for the agreement attestation record stored on a self-executing program to generate the agreement attestation record.

8. The method of claim 1, wherein the one or more second messages are configured to call a schema for corresponding to the respective signature attestation record stored on a self-executing program to generate the respective signature attestation record.

9. The method of claim 1, wherein the indication of the agreement document included in the agreement attestation record comprises a hash value of the agreement document.

10. The method of claim 1, further comprising:
storing the agreement document in association with a hash value of the agreement document in a data store.

11. The method of claim 1, wherein a schema associated with the signature attestation record includes an indication of a resolver self-executing program that validates the signature for the signature attestation record and prevents generation of signature attestation records for unspecified blockchain addresses.

12. An apparatus for data management, comprising:
one or more memories storing processor-executable code; and
one or more processors coupled with the one or more memories and individually or collectively operable to execute the code to cause the apparatus to:
receive, via a client application on a user device, an agreement document and respective indications of one or more blockchain addresses that are to sign the agreement document;
broadcast one or more first messages that are configured to generate an agreement attestation record via a blockchain network, wherein the agreement attestation record includes an indication of the agreement document; and
broadcast, after receiving an indication that at least one of the one or more blockchain addresses have generated a signature associated with the agreement attestation record, one or more second messages that are configured to generate a respective signature attestation record for the at least one blockchain address via the blockchain network, wherein the respective signature attestation record includes a reference to the agreement attestation record.

13. The apparatus of claim 12, wherein the one or more second messages are configured to invoke a hook contract that is included in the agreement attestation record, wherein the hook contract indicates a hook function that references a self-executing program supported by the blockchain network.

14. The apparatus of claim 13, wherein the hook function is a post signing hook that is invoked for each generated signature by the one or more blockchain addresses.

15. The apparatus of claim 13, wherein the hook function is a post completion hook that is invoked after generation of all signatures by the one or more blockchain addresses.

16. The apparatus of claim 13, wherein the reference to the self-executing program is received via the client application on the user device.

17. The apparatus of claim 12, wherein the one or more first messages are further configured to cause transmission of a notification message to the one or more blockchain addresses and wherein the notification message is indicative of the agreement attestation record.

18. The apparatus of claim 12, wherein the one or more first messages are configured to call a schema for the agreement attestation record stored on a self-executing program to generate the agreement attestation record.

19. A non-transitory computer-readable medium storing code for data management, the code comprising instructions executable by one or more processors to:
receive, via a client application on a user device, an agreement document and respective indications of one or more blockchain addresses that are to sign the agreement document;
broadcast one or more first messages that are configured to generate an agreement attestation record via a blockchain network, wherein the agreement attestation record includes an indication of the agreement document; and
broadcast, after receiving an indication that at least one of the one or more blockchain addresses have generated a signature associated with the agreement attestation record, one or more second messages that are configured to generate a respective signature attestation record for the at least one blockchain address via the blockchain network, wherein the respective signature attestation record includes a reference to the agreement attestation record.

20. The non-transitory computer-readable medium of claim 19, wherein the one or more second messages are configured to call a schema for corresponding to the respective signature attestation record stored on a self-executing program to generate the respective signature attestation record.
